(19) United States
(12) Patent Application Publication
(10) Pub. No.: US 2026/0151790 A1
(43) Pub. Date: Jun. 4, 2026

(54) MULTI PART PLASTIC AND FOAM ASSEMBLY SIMPLIFYING THE APPLICATION OF PRIMER SOLVENTS AND PLASTIC BONDING CEMENTS AND/OR AGENTS TO PLASTIC AND/OR PVC PIPING

(71) Applicant: Michael Dale MCGEE, Lake Havasu City, AZ (US)

(72) Inventor: Michael Dale MCGEE, Lake Havasu City, AZ (US)

(21) Appl. No.: 18/424,773

(22) Filed: Jan. 27, 2024

(51) Int. Cl. B05C 17/03

(52) U.S. Cl. CPC B05C 17/0308; B05C 17/0333

(57) ABSTRACT

The present invention comprises a system, means, and method facilitating the application of PVC primer or PVC cement to the inner surface of a PVC union or the outer surface of a PVC pipe. The invention consists of a threaded PVC primer or PVC cement container/can gravity feeding said PVC Primer or said PVC cement into and through a pump assembly and into an applicator assembly supporting a foam applicator transferring the PVC primer or PVC cement onto the inner surface or outer surface of a PVC union or PVC pipe to a predetermined depth thus reducing waste of the PVC primer or PVC cement and ensuring an even application of the primer or cement.

### FIELD OF INVENTION

The field of invention relates to devices that dispense primer solvent and plastic cement solutions onto and into plastic and/or PVC tubing in residential and commercial construction.

### BACKGROUND

New construction of residences and commercial structures more and more are using plastic and PVC piping for both interior and exterior applications. Typical application of both primer solvents and plastic cement solution onto the interior surface of plastic and PVC union connections and onto the exterior surface of plastic and PVC pipes generally results in either too little or too much primer solvents and too little or too much plastic cement.

The result of over application of primer solvents to the interior surfaces of unions and angled joints can cause roughening of the portion of the union or joint allowing particle matter traveling through the finished piping surfaces to catch onto resulting in bacteria and algae growth. The under application of primer solvents to the interior surfaces of unions and angled joints can result in a weak bond when a plastic or PVC pipe coated on the exterior portion of the pipe coated with plastic cement is inserted into the joint union. If the interior surface of the union is not properly prepared with a solvent primer, the plastic cement on the surface of the inserted plastic or PVC pipe may not properly bond with the interior surface of the union. This may result in a failed joint when the pipe assembly is put under pressure.

The result of over application of the plastic cement results in plastic cement buildup inside the end of the plastic or PVC pipe where it is inserted into the union. This buildup of plastic cement may result in microparticles of the cement breaking off the buildup and flowing away in the liquid stream passing through the pipe. If the liquid stream inside the pipe is water and is providing drinking water to people ingesting the water, the microparticles of the plastic pipe may be harmful to their health. Under application of plastic cement to the exterior of the plastic or PVC pipe the surface area of the bonding region between the pipe and the union is diminished. This may result in a failed joint when the pipe assembly is put under pressure.

### Problem Statement

What is needed is some device or system to guarantee the application of primer and plastic cement to the exterior surface of the pipe and the interior surface of the union without over or under application of the primer or the cement thus facilitating a more perfect joining of the pipe and union.

### SUMMARY

The instant invention discloses a plurality of devices and systems to alleviate most or all of the problems of installing plastic or PVC thin and heavy walled piping by simplifying the process of applying priming solutions and cements or other bonding solutions to making a joining of the pipes permanent.

### EMBODIMENTS

Reference will now be made in detail to various embodiments, examples of which are illustrated in the accompanying drawings. Wherever possible, the same reference numbers will be used throughout the drawings to refer to the same or like parts.

### Definitions

Primer Solvent: The purpose of primer is to begin the chemical reaction that softens PVC and to provide an even prepped surface for the solvent cement.

Plastic Cement: PVC Cement is a solvent. The way to connect PVC pipe and unions is through solvent welding.

PVC Primer/Cement container: The container containing the PVC Primer/Cement is connected to the application assembly such that the container is positioned upside down allowing the PVC Primer/Cement to be gravity fed to the applicator assembly when the assembly valve body is activated.

Foam applicator: becomes saturated when PVC Solvent/Cement flows into the glue tip saturating the foam applicator. As shown in FIG. 1, the foam applicator is shaped such that PVC Solvent/Cement coats the inside of a PVC union. Or is shaped such that the outer surface of the PVC pipe is inserted into the hollow center of the applicator.

### SHORT DESCRIPTION OF THE FIGURES

FIG. 1 is an exploded view of the apparatus making up the invention.

FIG. 2 is a cutaway depiction assembled components comprising the invention.

FIG. 3 shows a depiction of the invention applying PVC solvent or PVC cement to the inside surface of a PVC union with assembly 42/44 limiting the depth of application.

FIG. 4 shows a depiction of the invention applying PVC solvent or PVC cement to the outside surface of a PVC pipe with assembly 42/44 limiting the depth of application.

### EMBODIMENTS

Reference will now be made in detail to various embodiments, examples of which are illustrated in the accompanying drawings. Wherever possible, the same reference numbers will be used throughout the drawings to refer to the same or like parts.

In a first exemplary embodiment, an apparatus assembly and system are disclosed where PVC primer (solvent) or PVC glue is applied to the outer surface of the area of a PVC pipe that will be inserted into a union. The outer surface area of the PVC pipe to receive the PVC primer or PVC glue is limited to that portion of the outer end of the pipe that will be received into the union.

In a related embodiment the apparatus and system are alterable such that the application surface component of the invention may be changed such that the application surface may apply PVC primer (solvent) or PVC glue to the inner surface of a PVC union or to the outer surface of a PVC pipe.

In a second exemplary embodiment, a portion of the apparatus that dispenses PVC solvent or PVC glue is removable and replaceable to accommodate different inside diameters of unions and outside diameters of PVC pipe.

In another exemplary embodiment, an apparatus is shown that limits the dept of application to an inside surface of a PVC union and the outside surface of a PVC pipe.

Legend

| | |
|---|---|
| 6 | PVC Union Elbow |
| 8 | PVC Pipe |
| 12 | Threaded PVC Solvent/PVC Cement |
| | Container/Can |
| 14 | Plunger Cap |
| 16 | Spring Washer/Spring |
| 18 | O Ring(s) |
| 20 | Value Body |
| 22 | Valve Seal |
| 24 | Seal Washer |
| 26 | Seal Screw |
| 28 | Cover Gasket |
| 30 | Cover Screw |
| 32 | Valve Body Cover Threads |
| 34 | Valve Body Cover |
| 36 | PVC Solvent/Cement Applicator Tip |
| 38 | Foam Applicator |
| 40 | Lid |
| 42 | Depth Rod Tightening Know |
| 44 | Depth Rod |

### DETAILED DESCRIPTION OF THE INVENTION

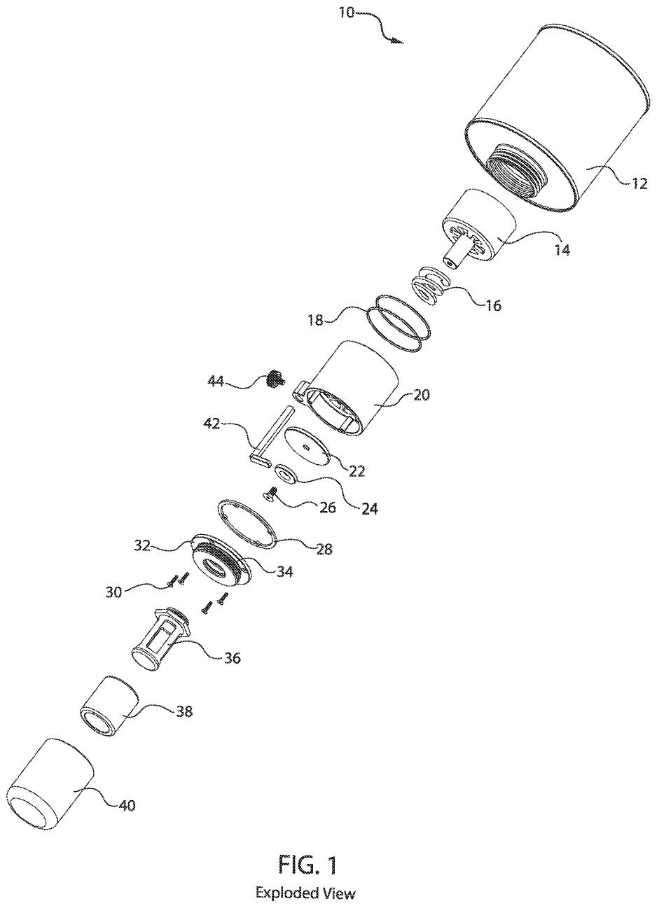

Now referencing FIG. 1 where 10 depicts an exploded view of the components comprising the invention. The instance invention is comprised of container 12, plunger cap 14, pump assembly (comprising spring washer 16, O-rings 18, valve body 20, valve seal 22, seal washer 24, seal screw 26, cover gasket 28, cover screw 30, valve body cover threads 32, and valve body cover 34). A PVC solvent/PVC cement applicator tip 36, foam applicator 38, foam applicator cover 40, and a depth rod 42 and tightening knob 44 which determine the area of either PVC elbow or PVC pipe covered by PVC solvent or PVC cement.

In the present depiction, container 12 is the storage reservoir containing either PVC solvent or PVC cement. Container 12 is mounted to the balance of components in the pump assembly 12 in an inverted orientation such that movement of the PVC solvent/cement is aided through the force of gravity.

Plunger cap 14 contains matching threads on its inside surface that mate and secure to the threads shown on container 12. The PVC solvent or PVC cement material residing in container 12 is thus gravity fed into the pump assembly when the user releases pressure on plunder cap 14 allowing valve body 20 to expand creating a void allowing PVC solvent/cement to flow out of Threaded PVC Solvent/PVC Cement Container/Can and into valve body 20.

When the user applies pressure to container 12, pump assembly 20 through 34 compressed valve body 20 forcing PVC solvent or PVC cement through components 20 through 34 and into glue tip 36 saturating foam applicator 38.

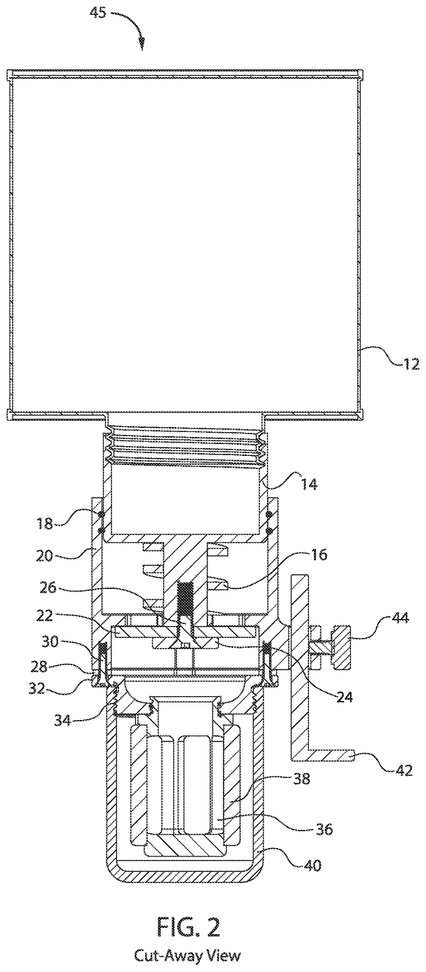

Now referencing FIG. 2 where 45 depicts the invention in a non-exploded view. Note that in this view, compression spring 16 is depicted as a coiled spring and not a washer type spring.

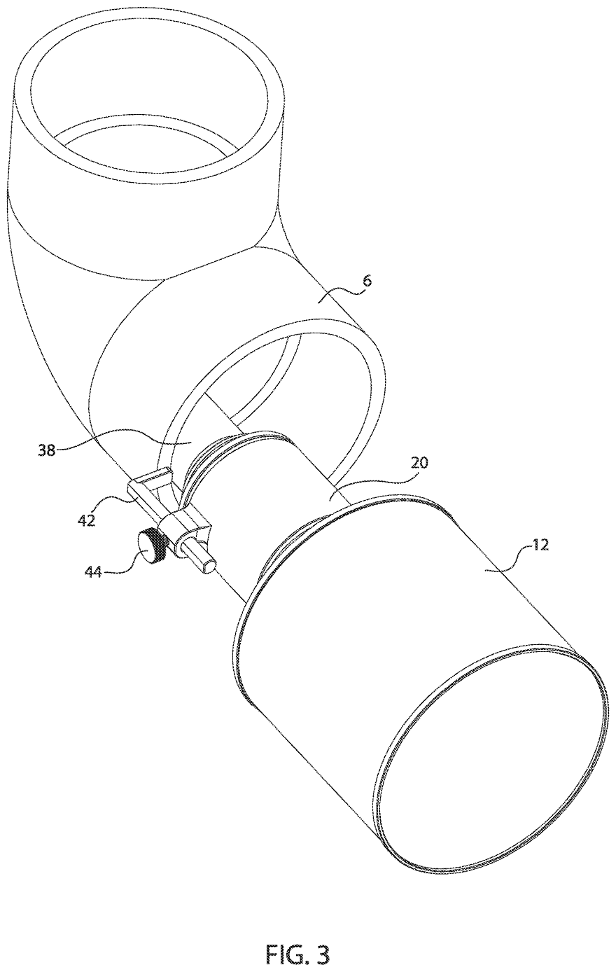

Now referencing FIG. 3 where 50 depicts components depth rod 42 and depth rod tightening knob 33. The depth that either PVC solvent or PVC cement will be applied to the inner surface of PVC elbow 6 is determined by the distance between the end of elbow 6 and right angle of depth rod 4. The distance between these two points is fixed and maintained by depth rod tightening knob 44.

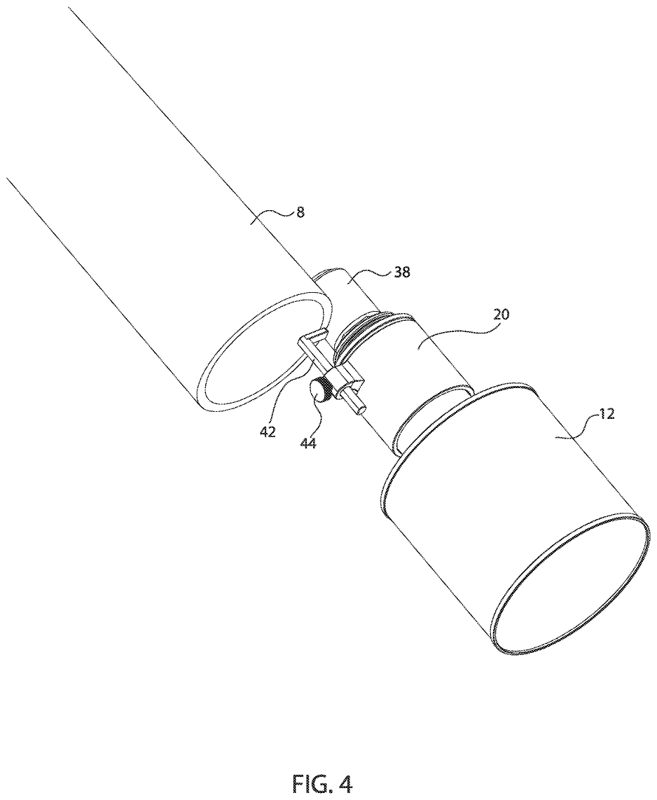

Now referencing FIG. 4 where 60 depicts components depth rod 42 and depth rod tightening knob 33. The depth that either PVC solvent or PVC cement will be applied to the outer surface of PVC pipe 8 is determined by the distance between the end of PVC pipe 8 and right angle of depth rod 4. The distance between these two points is fixed and maintained by depth rod tightening knob 44.

Objects and advantages of the present invention will become apparent to those skilled in the art upon reading this description in conjunction with the accompanying drawings, in which like reference numerals have been used to designate like or analogous elements.

The inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.
a. The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for a user to transfer PVC solvent or PVC cement from a container through a pump assembly to an applicator assembly to a PVC union or PVC pipe comprising:
a. means for transferring said PVC solvent or said PVC cement via gravity feed from a threaded container to said pump assembly,
b. means for pumping said PVC solvent or said PVC cement received from said container through said pump assembly to said applicator assembly,
c. means for applying said PVC solvent or said PVC cement to an inner surface of said PVC union or an outer surface of said PVC pipe.

2. A system for a user to transfer a low viscosity PVC solvent from a container through a pump assembly to an applicator assembly to the inside surface of a PVC union or to the outside surface of a PVC pipe comprising:
a. a container holding said PVC solvent, said container connects to said pump assembly through a threaded connector on said container to a threaded connector on said pump assembly and,
b. said pump assembly receiving said PVC solvent from said container, said user applies pressure to a lid on the output end of said pump assembly compressing a spring washer on the receiving end of said pump assembly that, when said pressure being applied to said lid is relieved allows said spring washer to return to its at rest state causing said PVC solvent to flow into said pump assembly and moving said PVC solvent in said pump assembly out of said pump assembly into a PVC solvent applicator tip and,
c. said PVC solvent PVC Solvent Applicator receives said PVC solvent and a foam applicator fitted over said PVC solvent applicator tip becomes saturated with said PVC solvent and,
d. said foam applicator is shaped such that said foam applicator is inserted into an opening in a PVC union coating the inside surface of said PVC union when a user rotates said PVC solvent container, said pump assembly and said applicator assembly in either direction around the inner surface of said PVC union or rotates said PVC union in either direction when said PVC Solvent Applicator is in contact with said inner surface of said PVC union.

3. The system of claim 2 where said spring washer is replaced with a coiled spring when a high viscosity PVC cement is to be transferred from said container through said pump assembly and,
a. said user determines the amount of travel of said coiled spring by said user applying more or less pressure on said lid resulting in said coiled spring to return to its at rest state causing said PVC cement to flow into said pump assembly and moving said PVC cement in said pump assembly out of said pump assembly into a PVC cement applicator tip,
b. said PVC cement applicator tip receives said PVC cement and a foam applicator fitted over said PVC applicator tip becomes saturated with said PVC cement and,
c. said foam applicator is shaped such that said foam applicator is shaped such that a PVC pipe is inserted into a hold in the end of said foam applicator coating the outside surface of said PVC pipe.

4. The system of claim 2 where said foam applicator fitted over said PVC cement applicator tip is shaped such that the center of said foam applicator is hollowed out such that a PVC pipe can be inserted into the center of said foam applicator coating the outside surface of said PVC pipe.
